(19) United States
(12) Patent Application Publication
(10) Pub. No.: US 2026/0267765 A1
(43) Pub. Date: Sep. 10, 2026

(54) MACHINE LEARNING-BASED ANOMALY DETECTION USING DATA CENTER METRICS

(71) Applicant: NVIDIA Corporation, Santa Clara, CA (US)

(72) Inventors: Shikhar SHIROMANI, Campbell, CA (US); Himanshu BHAT, Fremont, CA (US); Chanchal CHATTERJEE, San Jose, CA (US); Pradeep Kumar SHIMA, Santa Clara, CA (US)

(73) Assignee: NVIDIA Corporation, Santa Clara, CA (US)

(21) Appl. No.: 19/072,328

(22) Filed: Mar. 6, 2025

(51) Int. Cl. G06F 11/34

(52) U.S. Cl. CPC G06F 11/3452; G06F 11/3447

(57) ABSTRACT

Systems and methods for monitoring data center metrics using machine learning are disclosed. A system can obtain a first set of sensor readings from data center components during a first time period. The system can generate a dataset using the first set of sensor readings and a negative sampling function. The dataset can include labels generated according to a learned distribution derived from the first set of sensor readings. The system can update a machine learning model using the dataset to predict likelihoods of future anomalies in the plurality of data center components. The system can obtain a second set of sensor readings from the data center components during a second time period. The system can generate, using the machine learning model and the second set of sensor readings, a prediction of a future anomaly that may occur in at least one of the data center components.

### BACKGROUND

Data centers can operate with a wide range of different computing systems, including various components such as graphics processing units, field-programmable gate arrays, and hardware service controllers, among others. The complexity of these systems, combined with the dynamic nature of the data center environment, can make it challenging for existing approaches to monitor and identify potential anomalies or failures.

### SUMMARY

Data centers are expanding rapidly, with new clusters being created frequently to expand operating capabilities. Effective monitoring systems can check/ensure that data centers operate according to their designated capacity. Conventional approaches for data center monitoring typically rely on rule-based techniques, which can identify anomalies after they occur, resulting in machine downtime. Such traditional approaches can fail to comprehensively address data center node failure, as they primarily focus on component-specific failure detection, overlooking challenges associated with in-band metrics, such as firmware issues or latency-related problems. Furthermore, existing approaches can fail to provide detailed and actionable insights into the root causes of data center failures or anomalies, potentially leading to prolonged downtime as the underlying cause of the issue is identified.

The techniques described herein provide a significant improvement over conventional approaches by utilizing machine learning to monitor data center metrics and can provide actionable output in the form of alerts and dashboards. These techniques can implement Multidimensional Multimodal Anomaly Detection with Interpretation (MADI) to identify potential anomalies and/or failures in the data center before they actually occur, using negative sampling to generate training datasets and deep neural networks to efficiently learn the decision boundaries between normal and anomalous regions. Additionally, contrastive explanations of predicted anomalies or failures can be derived using approaches such as integrated gradients, providing detailed insights into the root causes of anomalies and significantly reducing troubleshooting time. The techniques described herein can also provide a detailed dashboard that presents device status and firmware versions, enabling proactive identification of anomalies to minimize downtime and maintain high availability of critical applications.

At least one aspect relates to one or more processors. The one or more processors can include one or more circuits. The one or more circuits can obtain a first set of sensor readings from a plurality of data center components of a data center during a first time period (e.g., using MADI-based technique). The one or more circuits can generate a dataset using the first set of sensor readings and a negative sampling function, the dataset comprising labels generated according to a learned distribution derived from the first set of sensor readings. The one or more circuits can update/train a machine learning model using the labels of the dataset to predict likelihoods of future anomalies in the plurality of data center components. The one or more circuits can obtain a second set of sensor readings from the plurality of data center components during a second time period. The one or more circuits can generate, using the machine learning model and the second set of sensor readings, a prediction of a future anomaly that may occur in at least one of the plurality of data center components (e.g., a predicted health metric).

In some implementations, the one or more circuits can preprocess the first set of sensor readings by averaging common sensor readings corresponding to the same component of the plurality of data center components. In some implementations, the first set of sensor readings further comprises one or more of power consumption data, memory utilization data, or processing core utilization data. In some implementations, the plurality of data center components comprises one or more of a baseboard, a graphics processing unit (GPU), a field-programmable gate array (FPGA), a hardware service controller (HSC), a peripheral component interconnect (PCI) re-timer, or a PCI express (PCIe) switch.

In some implementations, the one or more circuits can obtain a set of status data from the plurality of data center components. The one or more circuits can generate a graphical interface based at least on the set of status data. In some implementations, the set of status data comprises one or more of a device status or a firmware version for the plurality of data center components. In some implementations, the one or more circuits can generate the graphical interface to present the prediction of the future anomaly with the set of status data.

In some implementations, the one or more circuits can generate an alert upon the prediction satisfying an alert condition (e.g., a likelihood threshold) of the data center. In some implementations, the one or more circuits can obtain a third set of sensor readings from the plurality of data center components of the data center during a third time period. The one or more circuits can, responsive to determining that an update condition is satisfied, generate a second dataset using the third set of sensor readings, and update/re-train the machine learning model using the second dataset.

At least one aspect relates to a system. The system can include one or more processors. The system can identify a machine learning model updated using a first set of sensor readings accessed from a plurality of data center components of a data center during a first time period, the machine learning model to predict likelihoods of future anomalies in the plurality of data center components. The system can obtain a second set of sensor readings from the plurality of data center components during a second time period. The system can determine, based at least on the first set of sensor readings, that the second set of sensor readings satisfies an update condition for the machine learning model. The system can update the machine learning model based at least on the second set of sensor readings in response to determining that the second set of sensor readings satisfies the update condition.

In some implementations, the system can determine that the update condition is satisfied based at least on a Kullback-Leibler (KL) divergence between the first set of sensor readings and the second set of sensor readings. In some implementations, the system can generate a second dataset using the second set of sensor readings, the second dataset comprising labels generated according to a learned distribution derived from the second set of sensor readings. In some implementations, the system can generate the second dataset to include the second set of sensor readings and the first set of sensor readings. In some implementations, the system can generate the second dataset to include one or more synthetic examples generated according to the learned distribution, the one or more synthetic examples representing at least one anomalous condition of at least one data center component of the plurality of data center components.

At least one other aspect relates to a method. The method can include obtaining dataset comprising labels generated according to a learned distribution derived from a first set of sensor readings associated with a plurality of data center components during a first time period. The method can include updating a machine learning model using the labels of the dataset to predict likelihoods of future anomalies in the plurality of data center components. The method can include obtaining a second set of sensor readings associated with the plurality of data center components during a second time period. The method can include applying a second set of sensor readings to the machine learning model to generate a prediction of a future anomaly.

In some implementations, the method can include preprocessing the first set of sensor readings by averaging common sensor readings corresponding to the same component of the plurality of data center components. In some implementations, the first set of sensor readings can further comprise one or more of power consumption data, memory utilization data, or processing core utilization data. In some implementations, the plurality of data center components can comprise one or more of a baseboard, a GPU, an FPGA, an HSC, a PCI Re-timer, or a PCIe switch.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a small language model, a system for performing generative AI operations using a large language model, a system for performing generative AI operations using a vision language model, a system for performing generative AI operations using a multimodal language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for machine learning-based anomaly detection using data center metrics are described in detail below with reference to the attached drawing figures, wherein:

FIG. 1 is a block diagram of an example system for monitoring data center metrics using machine learning, in accordance with some embodiments of the present disclosure;

FIGS. 2A and 2B depict example views of a dashboard interface that may be presented in connection with the machine learning techniques described herein, in accordance with some embodiments of the present disclosure;

FIG. 3 is a flow diagram of an example method for machine learning-based anomaly detection using data center metrics, in accordance with some embodiments of the present disclosure;

FIG. 4 is a block diagram of an example computing device suitable for use in implementing at least some embodiments of the present disclosure; and

FIG. 5 is a block diagram of an example data center suitable for use in implementing at least some embodiments of the present disclosure.

### DETAILED DESCRIPTION

This disclosure relates to systems and methods for using machine learning to monitor data center metrics and provide actionable output to data center operators. Data centers are expanding rapidly, with new clusters being created frequently to expand operating capabilities. Due to the complexity of machine configurations and the dynamic nature of the data center environment, it may be impossible to characterize normal operating conditions with rule-based techniques. Such approaches can typically only identify anomalies after they occur for specialized cases, often resulting in machine downtime. Further, after faults or anomalies are detected, additional time is required to address the root cause of the anomaly.

Conventional approaches for data center monitoring fail to comprehensively address data center node failure. Most existing approaches primarily focus on component-specific failure detection, overlooking challenges associated with in-band metrics, such as firmware issues or latency-related problems. Additionally, existing approaches fail to provide detailed and actionable insights into the root causes of data center failures or anomalies once they occur. When anomalies are identified, conventional approaches do not offer detailed device status information, firmware versions, or other critical data points that are essential for troubleshooting, potentially leading to prolonged downtime as the underlying cause of the issue is identified.

To address these limitations, the systems and methods described herein provide techniques for using machine learning to monitor data center metrics and provide actionable output in the form of alerts and dashboards. To implement these techniques, data from the data center is collected over configurable time periods using application programming interfaces (APIs) and Intelligent Platform Management Interfaces (IPMIs). The data can include status information for each component in the data center as well as sensor data that can be used to perform machine learning applications, including but not limited to temperature, power consumption, and predefined threshold limits from various component such as baseboards, graphics processing units (GPUs), Field-Programmable Gate Arrays (FPGAs), Hardware Service Controllers (HSCs), PCI re-timers, and PCIe Switches, among others.

The techniques described herein can implement Multidimensional Multimodal Anomaly Detection with Interpretation (MADI) to identify potential anomalies and/or failures in the data center before they occur. In implementing MADI, negative sampling can be used to generate training datasets using unlabeled data where failures are complex, conditions are unpredictable, and/or new monitored components are added with undefined normal and failure operating conditions. The techniques described herein can use MADI to train/update a deep neural network to efficiently learn the decision boundaries between normal and anomalous regions, even when dealing with data that exhibits complex correlations and multimodal distributions.

Contrastive explanations of predicted anomalies or failures can be derived using approaches such as integrated gradients. Implementing integrated gradients for an anomaly can include accessing all the metrics collected for all nodes in the data center and determining the percentage contribution of each metric towards the anomaly. Each anomaly can be explained by metric attributions that assign a score to each metric, and a nearest contrastive normal point to illustrate how far off the anomaly is from normal. The explanations and contributions provided using such techniques can significantly reduce troubleshooting time for various anomalies.

The techniques described herein can provide a detailed dashboard that presents device status and firmware versions. The dashboard includes device status for devices such as GPUs, PCIe re-timers, Host Memory Controllers (HMCs), Baseboard Management Controllers (BMCs), Operating Systems (OS), FPGAs, Baseboards, Non-Volatile Memory Express (NVMe) devices, and PCIe Switches, among others. The dashboard can also include firmware versions for all major components within the data center and can provide indications where firmware updates are available. The dashboard can present indications of anomalies in the data center through an overall health score assigned to each node, which can indicate the likelihood of anomalies occurring at any given time. These approaches enable proactive identification of anomalies to minimize downtime and to maintain high availability of critical applications.

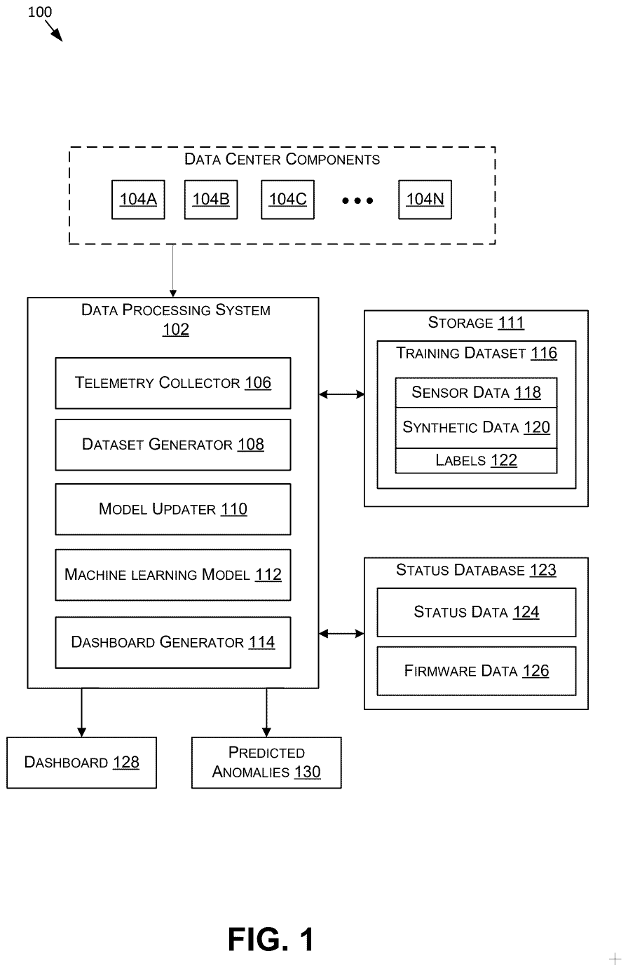

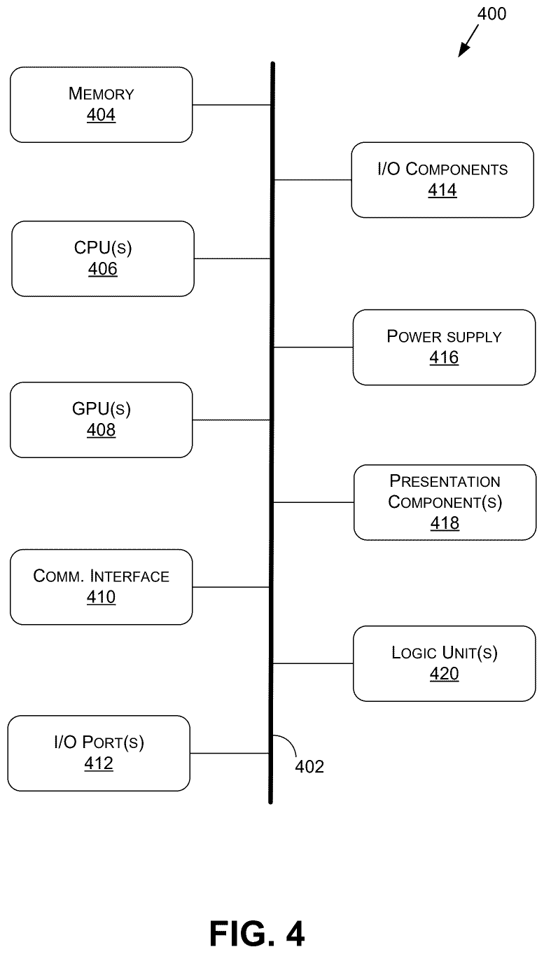

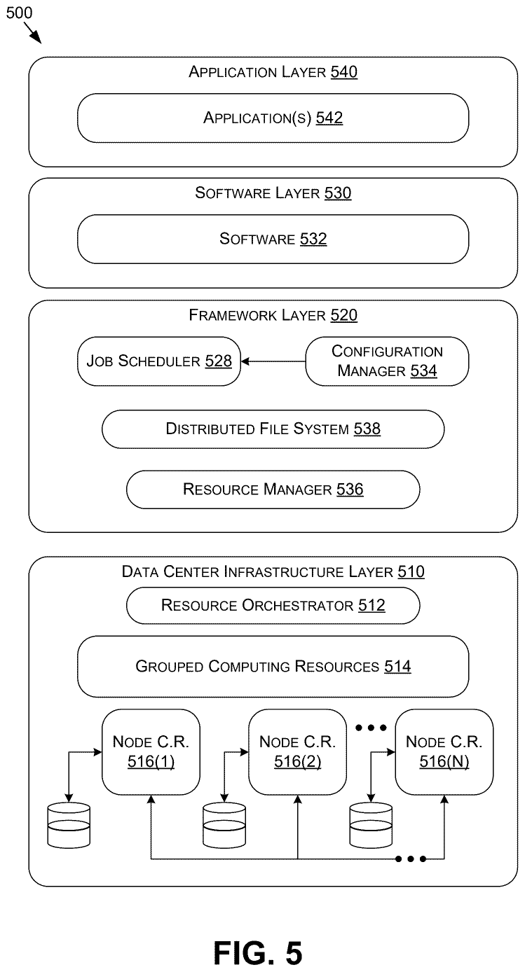

With reference to FIG. 1, FIG. 1 is an example computing environment including a system 100 for monitoring data center metrics using machine learning, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, in some embodiments, the system and methods described herein may be implemented using one or more computing devices or components thereof (e.g., as described in FIG. 4), and/or one or more data centers or components thereof (e.g., as described in FIG. 5).

The system 100 can be used to monitor data center metrics using various machine learning techniques. The system is shown as including data processing system 102 in communication with one or more data center components 104A-104N (sometimes generally referred to as “data center component(s) 104”), storage 111, and a status database 123. The data processing system 102 can provide one or more dashboards 128 and/or one or more predicted anomalies 130 as output. The data processing system 102 is shown as including a telemetry collector 106, a dataset generator 108, a model updater 110, a machine learning model 112, and a dashboard generator 114. The storage 111 may be internal or external to the data processing system 102 and can store one or more training datasets 116. An example training dataset 116 is shown as including sensor data 118, synthetic data 120, and corresponding labels 122. The status database is shown as including status data 124 and firmware data 126.

The data processing system 102 can include one or more processors, circuits, memory, and/or computing devices/systems that can perform the various techniques described herein. The data processing system 102 can be implemented, for example, in a data center or in a cloud computing environment in communication with one or more data centers. The data processing system 102 can implement the various techniques described herein to automatically monitor and predict future anomalies 130 in data center components 104. The data processing system 102 can also automatically log status data 124 and firmware data 126 for one or more data nodes to provide an interactive dashboard 128.

The data center components 104 can include any type of device that may operate in a data center environment. For example, the data center components 104 can include but not limited to one or more graphics processing units (GPUs), field-programmable gate arrays (FPGAs), hardware service controllers (HSCs), peripheral component interconnect (PCI) re-timers, or PCI express (PCIe) switches, among others. Different data center components 104 may perform different tasks within a data center and may execute different types of operations. For example, a GPU can be used for highly parallelizable compute-intensive tasks, such as scientific simulations, data analytics, or machine learning. and can include sensors to monitor temperature, power consumption, and utilization. Each of the data center components 104 can have different sensors, connectivity, and other characteristics that can affect how they interact within the data center and communicate information to the data processing system 102.

Different data center components 104 can include different sensors and interfaces that capture sensor data 118 and communicate information. For example, components such as GPUs, FPGAs, or CPUs may include sensors to monitor temperature, power consumption, and utilization. Examples of different component interfaces can include but are not limited to PCI Express, InfiniBand, or Ethernet. Furthermore, some components may have additional features, such as redundant power supplies or cooling systems, which can also impact their interaction with the data processing system 102. The data center components 104 can communicate with the data processing system 102 to provide sensor data 118, which can be used to monitor and predict future anomalies 130 in the data center. In some implementations, nodes of the data center may periodically (or according to another type of schedule) capture and store sensor data 118 for transmission to the data processing system 102 (e.g., in response to corresponding API requests, etc.).

The data center components 104 can communicate with the data processing system 102 to provide sensor data 118, status data 124, and firmware data 126, among any other information described herein. The sensor data 118 can be used to monitor and predict future anomalies 130 in the data center. In some implementations, the sensor data 118 can include information such as temperature, power consumption, processor and/or memory utilization, and/or other metrics that can be used to monitor the health and performance of the data center components 104. The data center components 104 and/or nodes of the data center including the data center components 104 can provide the sensor data 118 via suitable application programming interfaces (APIs) and/or other communication processes, such as RESTful APIs, message queues, or IPMI interfaces, or other out-of-band interfaces.

The data center components 104 can provide status data 124 to the data processing system 102, which can include information such as a component identifier with an indication of whether the component is online, offline, or in any other type of state. For example, the status data 124 can indicate that a GPU is online and operating within normal parameters, or that a PCIe re-timer is offline due to a hardware failure. The data processing system 102 can retrieve status data 124 for various types of data center components 104, including but not limited to GPUs, PCIe re-timers, HMCs, BMCs, OSes, FPGAs, Baseboards, NVMe devices, and PCIe Switches, among others. The status data 124 can be used by the data processing system 102 to generate one or more interactive dashboards 128, as described in further detail herein.

The data center components 104 can provide firmware data 126 to the data processing system 102, which can include information such as the currently flashed firmware for each component. For example, the firmware data 126 can indicate the version of various components of one or more nodes of the data center, such as the System Basic Input/Output System (SBIOS) firmware, Video Basic Input/Output System (VBIOS) firmware, Host Memory Controller (HMC) firmware, BMC firmware, Complex Programmable Logic Device (CPLD) firmware, or FPGA firmware, among others. The firmware data 126 can be used by the data processing system 102 to monitor the firmware versions of the data center components 104, generate interactive dashboards 128, and to identify circumstances where firmware updates may be provided.

The data center components 104 can provide sensor data 118, status data 124, and firmware data 126 to the data processing system 102 using any suitable approach. For example, one or more nodes of the data center may receive requests, such as API calls, IPMI-based requests, or other out-of-band requests, and provide one or more of the sensor data 118, status data 124, and/or firmware data 126 in response to the requests. In some implementations, the nodes can provide the data without necessarily receiving requests, for instance, by providing the data according to a reporting schedule. The schedule can be configurable via internal configuration settings and/or settings provided from the data processing system 102 and/or the operator of the data center. In some implementations, the data center components 104 can automatically provide one or more of the sensor data 118, status data 124, and/or firmware data 126 at regular intervals, such as every minute, hour, or day, or in response to specific events, such as changes in temperature, power consumption, or utilization.

The storage 111 can be a computer-readable memory that can store or maintain any of the information described herein. The storage 111 may be maintained locally at the data processing system 102 or within an external storage system in communication with the data processing system 102. In some implementations, the storage 111 may be an external server, distributed storage/computing environment (e.g., a cloud storage system), or any other type of storage device or system that is in communication with the data processing system 102.

The storage 111 can store one or more training datasets 116, which can be used to update/train one or more machine learning models 112. The training dataset 116 can be generated by the dataset generator 108, as described in further detail herein. The training dataset 116 can include a set of training examples. Each training example can include at least a portion of the sensor data 118 or synthetic data 120 paired with at least one corresponding label 122. The sensor data 118 can be structured in various ways. For example, the sensor data may include time series data (e.g., of a predetermined time window, etc.). The sensor data 118 can be stored in data structures such as arrays, lists, or dictionaries, and can be indexed by timestamp, component identifier, or other relevant metadata. Examples of sensor data 118 can include temperature readings, power consumption values, utilization metrics, and latency measurements, among others.

In some implementations, the sensor data 118 in the training dataset 116 can represent a wide range of conditions, including normal operating conditions, anomalous conditions, and edge cases. At least a portion of the sensor data 118 can represent a positive sample, such as normal, non-anomalous data, which can be used to update/train the machine learning model 112 to recognize normal operating conditions. One or more training examples of the training dataset 116 can include synthetic data 120, which can be generated according to the MADI techniques described herein. The synthetic data 120 can be generated to simulate anomalous sensor readings from one or more data center components 104, such as data that might be collected during a hardware failure or any other possible anomalous event or condition that may occur in a data center. The synthetic data 120 can be stored in a similar structure as the sensor data 118, such as in arrays, lists, or dictionaries, and can be indexed by timestamp, component identifier, or other relevant metadata.

Each training example of the training dataset can include at least one label 122 that corresponds to a respective portion of sensor data 118 or synthetic data 120. The labels 122 can indicate whether the corresponding sensor data 118 or synthetic data 120 represents an anomalous or non-anomalous condition of one or more data center component(s) 104. For example, a label 122 can indicate that a particular temperature reading from a GPU is within normal operating range, or that a set of power consumption values from a group of FPGAs indicates an anomalous condition, among any other possible condition. As described in further detail herein, the labels 122 can be used to update/train the machine learning model 112 to accurately classify sensor data 118 received from the data center components 104 anomalous or non-anomalous, allowing the model to detect potential future anomalies 130 in one or more data centers.

The status database 123 can be any type of database or storage that can store information. The status database 123 can be a computer-readable memory that can store or maintain any of the information described herein. The status database 123 may be maintained locally at the data processing system 102 or within an external storage system in communication with the data processing system 102. In some implementations, the status database 123 may be an external server, distributed storage/computing environment (e.g., a cloud storage system), or any other type of storage device or system that is in communication with the data processing system 102. Although shown as separate from the storage 111, it should be understood that in some implementations, the status database 123 may be included as part of, or may be the same as/an extension of, the storage 111.

The status database 123 is shown as storing status data 124 and/or firmware data 126 for one or more data center components 104 and/or nodes of the data center associated therewith. The status data 124 can include any information relating to the state of the data center components 104, such as indications of whether each component is online, offline, or in a fault state, among others. For example, the status data 124 can indicate that a particular GPU is operating within normal parameters, or that a PCIe Re-timer is offline due to a hardware failure. The status data 124 can be used by the data processing system 102 to generate one or more interactive dashboards 128, which can provide a visual representation of the current state of the data center components 104. The status data 124 can be collected from any of the data center components 104 described herein, including but not limited to GPUs, PCIe Re-timers, HMCs, BMCs, OSes, FPGAs, Baseboards, NVMe devices, and PCIe Switches, among others. The status data 124 can be used to monitor the health and performance of the data center components 104, and to diagnose current faults or issues with data center nodes, as described herein.

The firmware data 126 can include any information relating to the firmware of one or more data center components 104, including but not limited to the version number, installation date, and any other relevant details. For example, the firmware data 126 can indicate the version of the SBIOS firmware, VBIOS firmware, HMC firmware, BMC firmware, CPLD firmware, or FPGA firmware, among others. In some implementations, the firmware data 126 can include indications of when the firmware was last installed or updated, as well as any system events relating to the provisioning or installation of firmware, such as updates, rollbacks, or other relevant information. The firmware data 126 can be used by the data processing system 102 to monitor the firmware versions of the data center components 104, generate interactive dashboards 128, and to identify circumstances where firmware updates may be provided, as described herein.

Referring now to the operations of the data processing system 102, the data processing system 102 can execute the telemetry collector 106 to access various data from the data center components 104. The telemetry collector 106 can include software, hardware, or combinations thereof. The telemetry collector 106 can communicate with the nodes of the data center to retrieve or access sensor data 118, status data 124, and/or firmware data 126, via one or more corresponding network interfaces or other types of communication interfaces. The telemetry collector 106 can communicate with the nodes of the data center using various protocols, such as APIs, message queues, IPMI interfaces, or out-of-band interfaces, among others. For example, the telemetry collector 106 can send API requests to the nodes of the data center to retrieve sensor data 118, such as temperature readings, power consumption values, or utilization metrics, among other types of sensor data. In some implementations, the telemetry collector 106 can receive sensor data 118, status data 124, and/or firmware data 126 from the nodes of the data center, and/or from the data center components 104 directly or indirectly, according to a reporting/retrieval schedule, which can be configurable via internal configuration settings and/or settings provided from the data processing system 102 and/or the operator of the data center.

In some implementations, the telemetry collector 106 can provide sensor data 118 to the dataset generator 108 to generate one or more training datasets 116, which can be used to update or train one or more machine learning models 112. The telemetry collector 106 can provide and/or make available (e.g., via storage in one or more data structures of the data processing system 102, etc.) real-time (or near real-time) sensor data 118 to one or more machine-learning model 112 to generate one or more predictions of potential future anomalies 130, as described in further detail herein. For example, the telemetry collector 106 may store sets of time-series sensor data 118 (or any other telemetry data described herein) in one or more regions of memory of the data processing system 102 and/or in the storage 111. The sensor data 118 may be stored in association with identifiers of the data center components 104 to which the sensor data 118 corresponds and/or timestamps indicating the time the sensor data 118 was captured,

In some implementations, the telemetry collector 106 can update the status database 123 with the retrieved status data 124 and/or firmware data 126. The telemetry collector 106 may update the status database 123 using according to an update schedule, in response to operator input at the data processing system 102, and/or or in response to one or more requests from external computing systems, among others. The update schedule can be configurable, and can be based on various factors, such as the type of data being retrieved, the frequency of updates, or the priority of the data, in some implementations. For example, the telemetry collector 106 can update the status database 123 every minute, hour, or day, or in response to specific events, such as changes to firmware 126 or upon detecting changes in state of one or more data center components 104.

In some implementations, the telemetry collector 106 can retrieve, receive, or otherwise access status data 124 and/or firmware data 126 from the data center components 104 using various approaches. For example, the telemetry collector 106 can use IPMI interfaces to retrieve status data 124 and/or firmware data 126 from the data center components 104 or can use one or more APIs to retrieve sensor data 118 from the nodes of the data center. In some implementations, the telemetry collector 106 can also use message queues or other out-of-band interfaces to communicate with the nodes of the data center and retrieve or otherwise access status data 124 and/or firmware data 126.

The data processing system 102 can generate one or more training datasets 116 using sensor data 118 retrieved/accessed by the telemetry collector 106. For example, the telemetry collector 106 can obtain a first set of sensor data 118 from one or more of the data center components 104 during a first time period. The first set of sensor data 118 can correspond to positive examples of normal operating behavior, which can be ensured during the first time period by selecting a time period when the data center components 104 are operating under normal conditions, such as during a maintenance window or when the data center is under a known workload or operating conditions. For example, the first time period can be determined by analyzing historical data to identify a time period when the data center components 104 were operating within normal parameters, such as when the temperature, power consumption, and utilization metrics were within predetermined thresholds.

In some implementations, the first time period can be determined by using a sliding window approach, where the dataset generator 108 continuously collects sensor data 118 over a moving window of time, such as a 24-hour window, to capture a representative sample of normal operating behavior during which it is verified that no anomalies occurred in the data center. The dataset generator 108 can determine the first time period such that sufficient sensor data 118 is captured from the data center components 104 to accurately represent the feature space of normal operating behavior among the sensor data 118. In some implementations, the first time period may be a predetermined or configured value retrieved from configuration settings and/or specified via an operator of the data processing system 102.

The dataset generator 108 can allocate one or more regions of memory in the storage 111 for a training dataset 116 that is to be generated and can store the first set of sensor data 118 as part of one or more training examples for the machine-learning model 112. The dataset generator 108 can generate labels 122 for the training examples including the first set of sensor data 118 to indicate that the training examples do not indicate anomalous behavior. The labels 122 may be binary labels, numerical labels, or any other type of label that indicates the training example represents non-anomalous behavior or conditions. In some implementations, the dataset generator 108 can generate additional training examples by adding noise or perturbations to the first set of sensor data 118, such as by adding Gaussian noise or by applying a transformation to the sensor data 118, to increase the diversity of the training dataset 116 and improve the robustness of the machine-learning model 112. The parameters of the noise and/or perturbations can be selected such that the additional training examples do not correspond to anomalous behavior (e.g., overheating from elevated temperatures, excessive overutilization or underutilization, etc.).

In some implementations, the dataset generator 108 can preprocess at least a portion of the first set of sensor data 118. For example, the dataset generator 108 can average common sensor data 118 corresponding to the data center components 104 during the first time period or during one or more windows of time during the first time period. Pre-processing can be performed to reduce noise and variability in the sensor data 118, which can improve the accuracy of the machine learning model 112 once trained/updated using the training dataset 116. For example, if multiple temperature sensors are monitoring the temperature of a single GPU, the dataset generator 108 can average the temperature readings from these sensors to produce a combined temperature reading. In some implementations, the dataset generator 108 can apply preprocessing techniques such as normalization or feature scaling. For example, the dataset generator 108 can normalize one or more temperature readings, power consumption values, and/or utilization values to a common scale, such as a range of 0 to 100, to prevent features with large ranges affecting the performance of the machine learning model 112.

The dataset generator 108 can use a learned distribution derived the positive training examples (e.g., the sensor data 118 captured under normal operating conditions) to generate one or more synthetic training examples (e.g., synthetic data 120). The synthetic data 120 can be generated using a negative sampling function, implemented according to a MADI function. For example, the dataset generator 108 can generate synthetic data 120 by modeling sensor readings of the data center components 104 in a high-dimensional feature space, where the number of dimensions corresponds to the number of features, such as temperature, utilization, voltage, current, power, and others, of the sensor data 118.

The synthetic data 120 can be generated to occupy a feature space that is not occupied (or potentially sparsely occupied) by the sensor data 118 corresponding to normal operating conditions. To do so, the dataset generator 108 can determine the normal operating feature space of the sensor data 118, which can be learned using various techniques, such as kernel density estimation (KDE), Gaussian approximation, or other methods. For example, the normal operating feature space can be modeled using a bounding region, such as an axis-aligned bounding box (AABB), which can be defined by the minimum and maximum values for each feature. In some implementations, a covariance matrix and mean can be used to model the normal operating feature space using a Gaussian approximation.

The dataset generator 108 can generate synthetic data 120 by randomly generating datapoints in the high-dimensional feature space using techniques such as uniform random sampling, Gaussian sampling, or any other suitable random generation approach. The randomly generated values may be bounded according to physical limitations of particular sensors or normal sensing ranges (e.g., temperature falling within a predetermined maximum and minimum range, etc.). The dataset generator 108 can filter and/or select from the randomly generated samples to identify points outside of the learned distribution of the sensor data 118. To do so, the dataset generator 108 can use various techniques, such as distance-based filtering, density-based methods, or isolation forest-based approaches, among others. For example, in some implementations, the dataset generator 108 can retain points that are farther than a threshold from the positive samples (e.g., sensor data 118 corresponding to normal operating conditions) using Euclidean distance, or remove points from the set of generated samples that fall in regions of high density within the feature space as determined by KDE, a fitted Gaussian model, or any other suitable approach.

The dataset generator 108 can generate the synthetic data 120 such that the amount of synthetic data 120 is large enough to indicate a diverse set of anomalies but balanced relative to the training examples including sensor data 118 indicating non-anomalous operating conditions to avoid classifier bias. The dataset generator 108 can generate training examples including the synthetic data 120 with labels 122 similar to those described herein. For example, the labels 122 for synthetic data 120 can be generated to indicate the corresponding synthetic data 120 represents an anomalous condition of one or more data center components 104. As described in further detail herein, the training dataset 116 generated using these techniques can be used to train/update a machine learning model 112 to accurately classify sensor data 118 received from the data center components 104 as anomalous or non-anomalous, allowing the model to detect potential future anomalies 130 in one or more data centers. In some implementations, the dataset generator 108 can generate additional synthetic data 120 to update the training dataset 116 over time, for example, in response to changes in data center components 104, in response to requests from operators of the data processing system 102, or in response to any other similar condition/input.

The machine learning model 112 can predict likelihoods of future anomalies 130 in one or more of the data center components 104. In some implementations, the machine learning model 112 can include a neural network classifier, which can be trained using the training dataset 116 generated by the dataset generator 108, as described in further detail herein. In one example, the machine learning model 112 can include a deep neural network classifier having multiple layers, such as an input layer, one or more hidden layers, and an output layer. Furthering this example, the input layer can receive a set of sensor data 118 as input, the hidden layers can perform various transformations on the received sensor data 118, and the output layer can generate predictions of potential future anomalies 130. In some implementations, the machine learning model 112 can include a fully connected network, a recurrent neural network (RNN), or a convolutional neural network (CNN), among others.

In some implementations, the machine learning model 112 can generate binary classifications, such as one of a first value indicating that the input data represents a future anomaly 130 or a second value indicating that the input data does not represent a future anomaly 130. In some implementations, the machine learning model 112 may generate output that indicates the type of anomaly. For example, the output layer of the machine learning model 112 may generate a vector indicating different classifications of different types of anomalies, such as temperature-related anomalies or power consumption-related anomalies, among others. The output of the machine learning model 112 can correspond to the same structure as the labels 122, such that the output of the machine learning model 112 can be compared with corresponding labels 122 during training/updating of the machine learning model 112.

The data processing system 102 can execute the model updater 110 to train/update the machine learning model 112. The model updater 110 can include software, hardware, or combinations thereof. The model updater 110 can train/update the machine learning model 112 using the sensor data 118, the synthetic data 120, and the labels 122 of the training dataset 116 to predict likelihoods of future anomalies 130 relating to one or more of the data center components 104. The training/update process can include providing input data training examples of the training dataset 116 to the machine learning model 112 and executing the machine learning model 112 to generate an output. The input data of the training examples can include at least a portion of sensor data 118 or a portion of synthetic data 120. In one example, the model updater 110 can provide the training examples to the machine learning model 112 in batches. In such implementations, the parameters of the machine learning model 112 can be updated after each batch has been provided, based on the output generated for each training example in the batch. In some implementations, the model updater 110 can provide the training examples to the machine learning model 112 one at a time, updating the parameters of the machine learning model based on the output generated for each training example.

The model updater 110 can update the parameters of the machine learning model 112, including but not limited to weights, biases, or other types of parameters. For example, the model updater 110 can use stochastic gradient descent (SGD) or Adam to update the parameters of the machine learning model 112. In such implementations, the parameters can be updated based on the gradient of a loss function with respect to the parameters. The model updater 110 can calculate the loss using various loss functions, such as binary cross entropy loss, cross entropy loss, focal loss, hinge loss, or contrastive loss. For example, binary cross entropy loss can be used for binary classification problems, where the goal is to predict a binary label (e.g., “0” or “1”, which in this example can include a classification of anomalous for “1” and a classification of non-anomalous for “0”) for each input. In such implementations, the loss function can be defined as the difference between the predicted probabilities and the corresponding labels 122. The model updater 110 can use the calculated loss to update the parameters of the machine learning model 112 (e.g., using a suitable optimization function) to minimize the loss. In some implementations, the model updater 110 can terminate training when a specified condition is met, such as when the loss reaches a certain threshold, when a maximum number of iterations is reached, or when performance on a validation set (e.g., a subset of the training examples of the training data 116 that are not used for training/updating the machine learning model 112) stops improving.

Once the machine learning model 112 is trained/updated, the data processing system 102 can execute the machine learning model 112 using input sensor data 118 retrieved/accessed by the telemetry collector 106 to generate indications of predicted anomalies 130. For example, the machine learning model 112 can be executed to generate output by providing the input sensor data 118 (e.g., as an input vector or other suitable data structure) to the input layer of the machine learning model 112. The machine learning model 112 can be executed to process the input sensor data 118 through one or more hidden layers and generate output at the output layer. The output of the machine learning model 112 can correspond to a probability or likelihood that an anomaly 130 could occur in the data center in the near future. In some implementations, the output may be a scalar value indicating a likelihood that a predicted anomaly 130 is to occur within the data center in the near future (e.g., indicated by irregular operating conditions in the sensor data 118, etc.).

The data processing system 102 can use the output of the machine learning model 112 to provide an indication that an anomaly 130 could occur in the data center in the near future. For example, the data processing system 102 can generate an alert or notification to an operator of the data center, indicating that an anomaly 130 could occur in the near future (e.g., within a predetermined time period after the input sensor data 118 was captured, etc.). In some implementations, indications of the predicted anomalies 130 (or lack of anomalies 130, depending on the output of the machine learning model 112) may be provided for display via one or more graphical user interfaces.

In some implementations, the data processing system 102 can use techniques such as integrated gradients to identify features of the sensor data 118 that contributed to the prediction of any future anomalies 130. An input feature of the sensor data 118 refers to a specific aspect or attribute (e.g., value or collection of values) of the input sensor data 118, such as a temperature value, a power consumption value, or utilization value, which can be provided as input to the machine learning model 112. The integrated gradients technique can be used to assign a contribution score to each input feature, indicating the extent to which each feature contributed to the predicted anomaly 130. To calculate the contribution scores, the data processing system 102 can compute the gradient of the output of the machine learning model 112 with respect to each input feature of the input sensor data 118. The gradient represents the rate of change of the output with respect to each input feature and can be used to determine the contribution of each feature to the predicted anomaly 130.

The contribution scores for each input feature can be calculated by integrating the gradients of the output of the machine learning model 112 with respect to each input feature, along a path from a baseline input to the input sensor data 118. The baseline input can be a default or neutral input, such as an input with all features set to zero. The integrated gradients can be calculated using a numerical integration technique, such as the trapezoidal rule or Simpson's rule. In some implementations, the resulting contribution scores can be normalized to such that they sum to one. For example, if the contribution score for a particular temperature reading of a data center component 104 is 0.4, this indicates that the temperature reading contributed 40% to the predicted anomaly 130. The data processing system 102 can use the contribution scores to identify the most relevant input features that contributed to the predicted anomaly 130 and provide this information to an operator of the data center via a graphical user interface or other suitable output. In some implementations, the data processing system 102 can provide the contribution scores to an operator of the data center via one or more notifications (e.g., email, dashboard notification, etc.) or via any other type of suitable output. The contribution scores may be formatted in any suitable format, including graphs, plots, numerical presentations, or combinations thereof.

In some implementations, the data processing system 102 can generate an alert upon the prediction satisfying an alert condition of the data center. For example, the data processing system 102 can generate an alert when the machine learning model 112 generates a classification of a predicted anomaly 130. In some implementations, the data processing system 102 can retrieve/access and process sensor data 118 using the machine learning model 112 in real-time or near real-time, such that predicted anomalies 130 can be identified via alerts before they can affect data center operation. In some implementations, the alert can include information such as the type of anomaly, the likelihood of the anomaly, and the data center components 104 that are likely to be affected and/or may be responsible for the predict anomaly 130. In some implementations, the alert can also include information such as the severity of the predicted anomaly, the identifiers of the data center components 104 that are likely to be affected, and the recommended actions to take to prevent or mitigate the anomaly.

In some implementations, the alert can be provided in various forms, such as a graphical user interface, a notification on a mobile device, or an email to the operator of the data center, among others. In some implementations, the alert can also include information such as the contribution scores of the input features that contributed to the predicted anomaly, such as the temperature, power consumption, or utilization of the data center components 104. The alert can be customized (e.g., via internal configuration settings, etc.) to include various types of information, such as the name of the data center, the location of the data center, and/or any information relating to the data centers or the nodes thereof. In some implementations, the alert can also include information such as the historical data of the data center components 104, such as the temperature, power consumption, or utilization over time, to provide context to the predicted anomaly 130.

In some implementations, the data processing system 102 can execute the model updater 110 to update the machine-learning model 112 according to an update schedule, in response to changes in the data center or the data center components 104, in response to operator input at the data processing system 102, or any other type of update condition. The model updater 110 can update the machine learning model 112 using the techniques described herein according to the update condition. The model updater 110 can update the machine learning model 112 at predetermined intervals to address data distribution shifts. The model updater 110 can quantify distribution shifts in the sensor data 118 based on Kullback-Leibler (KL) divergence, which can be used to measure the difference between two probability distributions. In the context of the model updater 110, KL divergence can be used to measure the difference between the distribution of the sensor data 118 at different points in time. By monitoring the KL divergence between the current sensor data 118 and the sensor data 118 of the training dataset 116 used to train the machine learning model 112, the model updater 110 can detect when the distribution of the sensor data 118 has changed more than a predetermined threshold (e.g., which may be configurable via configuration settings of the data processing system 102), indicating that the machine learning model 112 may no longer be accurate. In some implementations, when the KL divergence exceeds the predetermined threshold, the model updater 110 can initiate an update of the machine learning model 112 to maintain its accuracy.

The model updater 110 can perform a similar training/update process as described herein to update the machine learning model 112. This can include generating a second training dataset 116 via the dataset generator 108, which can involve capturing sensor data 118 corresponding to positive samples (e.g., normal behavior), generating synthetic data 120 based on these examples as described herein, and generating the training dataset 116 using both the sensor data 118 and the synthetic data 120. In some implementations, the dataset generator 108 can update an existing training dataset 116 with additional sensor data 118 and corresponding synthetic data 120. In some implementations, the dataset generator 108 can regenerate a second training dataset 116 without necessarily using data from a training dataset 116 previously used to train/update the machine learning model 112. The model updater 110 can automatically update the machine learning model 112 using the captured data.

The data processing system 102 can execute the dashboard generator 114 to generate a dashboard 128 (e.g., a graphical interface) based at least on the status data 124 obtained from one or more of the data center components 104. The dashboard generator 114 can include hardware, software, or combinations thereof. In some implementations, the dashboard generator 114 can generate a web-based dashboard 128 that can be accessed via a web browser, such that the status of the nodes of the data center and the data center components 104 can be monitored remotely. In some implementations, the dashboard generator 114 can communicate with a native application installed on a computing device in communication with the data processing system 102 to present the dashboard.

The dashboard 128 can present various types of information, such as plots, graphs, tables, and lists, to provide a detailed overview of the status of the data center. For example, the dashboard 128 can display plots of temperature, power consumption, and utilization metrics over time. The dashboard 128 can display tables and lists of status data 124, such as the current state of each data center component 104, including whether it is online, offline, or in a fault state. In some implementations, the dashboard 128 can provide information relating to the data center components 104 included in one or more nodes of the data center. In some implementations, the dashboard can enable navigation between multiple data centers, such that status data 124 from multiple data centers can be monitored in real-time from a common interface. In some implementations, the dashboard generator 114 can generate the graphical interface to present indications of predicted anomalies 130.

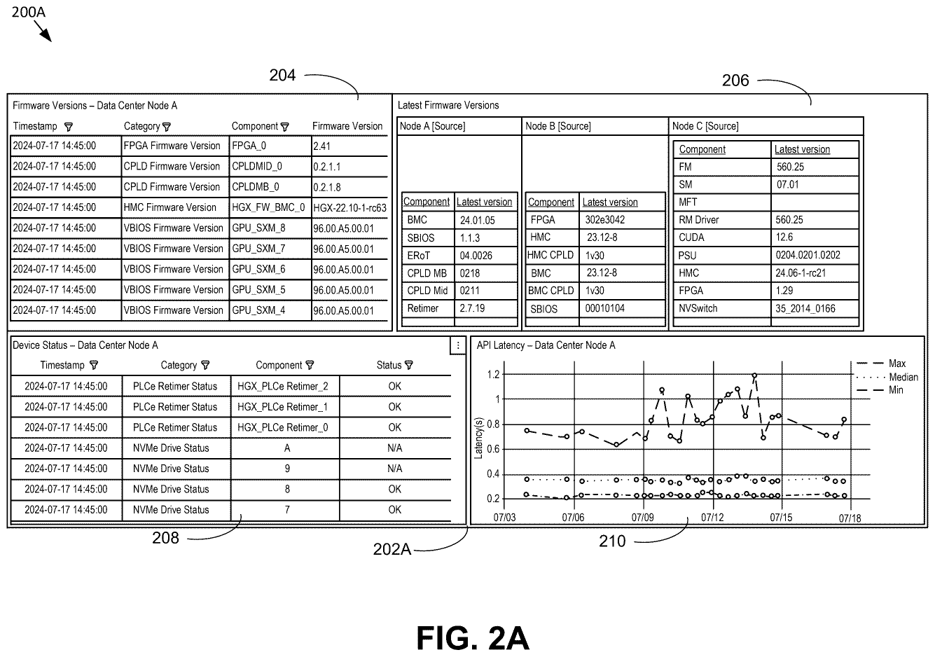

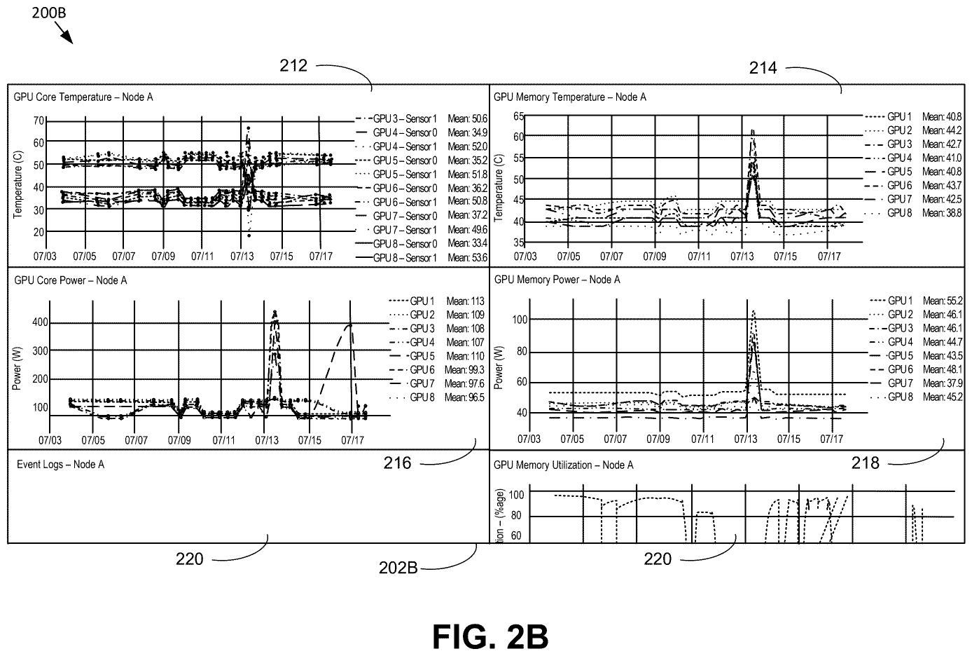

The dashboard 128 can provide links, buttons, or other interactive elements that point to locations where up-to-date firmware can be retrieved, such as a database or an external computing system. For example, the dashboard generator 114 can retrieve information about available firmware updates for one or more data center components 104 from a database, such as a version number, installation date, and a link to download the update. The dashboard 128 can then display this information as part of the dashboard 128. In some implementations, the dashboard generator 114 can retrieve information about available firmware updates from an external computing system, such as a cloud-based repository of firmware updates. Examples interfaces that may be presented as part of the dashboard 128 are shown in FIGS. 2A and 2B.

Referring to FIGS. 2A and 2B in the context of the components described in connection with FIG. 1, depicted are example diagrams 200A and 200B of a dashboard interface (e.g., the dashboard 128) that may be presented in connection with the machine learning techniques described herein, in accordance with some embodiments of the present disclosure. FIG. 2A shows the graphical interface 202A, which is shown in this example as including a first region 204, a second region 206, a third region 208, and a fourth region 210. The first region 204 can present the installed firmware versions of one or more data center components 104 of a node of the data center, which in this example is “Node A.” This information can be used to monitor and track the firmware versions of the components, allowing for identification of potential compatibility issues or updates.

The graphical interface 202A can include the second region 206, which in this example shows the currently available firmware for data center components of different node types (e.g., Nodes A, B, and C). The second region 206 can include interactive elements to access and/or download the firmware packages for each type of node and/or data center component. In some implementations, the second region 206 and/or the first region 204 can indicate when one or more data center components 104 have at least one firmware upgrade available. In some implementations, the first region 204 and/or the second region 206 may include an indication of when the firmware and/or other software of the data center components 104 of a node have been updated and/or modified.

The graphical interface 202A can include a third region 208, which can display status data of each data center component 104 of Node A. The third region 208 can provide real-time or near real-time information on the operational status of the components, in some implementations. The status information may be retrieved from the status database 123, as described herein. As shown in this example, status data is presented with an identifier of a corresponding data center component 104 and a timestamp corresponding to the time the status data 124 was retrieved/accessed for the corresponding data center component 104. Although data center components 104 are shown for a single node in the third region 208 in this example, it should be understood that status data 124 for any number of data center nodes may be presented in the third region 208 and/or other regions of the graphical user interface 202A.

The graphical user interface 202A is shown as including a fourth region 210, which can indicate time series data that tracks latency for API requests for sensor data 118, status data 124, and/or firmware data 126. In this example, three time-series statistics are shown on a daily basis: the maximum API latency encountered on each day, the minimum API latency encountered on each day, and the average (mean) API latency encountered on each day. Although API latency is shown here, it should be understood that any type of time series data may be presented via the graphical user interface 202A, such sensor data 118. Various graphical elements presented via the graphical user interface 202A can cause the graphical user interface 202A to transition to other interfaces presenting different information.

FIG. 2B shows an example graphical user interface 202B, which may be navigated to upon interaction with one or more interactive elements of the graphical user interface 202A, in some implementations. The graphical user interface 202B includes a first region 212, which in this example can include a plot of time series data of GPU core temperature on a daily basis, broken down by different sensors for GPUs one through eight of Node A. The first region 212 can provide real-time or near real-time information on the temperature of the GPUs, in some implementations. The graphical user interface 202B can include a second region 214, which in this example can include a plot of time series data of GPU memory temperature on a daily basis, broken down by GPUs one through eight of Node A.

As shown, the graphical user interface 202B includes a third region 216, which in this example can include a plot of time series data of GPU core power on a daily basis, broken down by GPUs one through eight of Node A, The graphical user interface 202B can include a fourth region 218, which in this example can include a plot of time series data of GPU memory power on a daily basis, broken down by GPUs one through eight of Node A. Sensor data values in these example regions have been averaged on a daily basis. However, it should be understood that any suitable timescale may be selected and/or presented via the graphical user interface 202B, and that the dashboards 128 described herein are not limited to the presentation of averaged, daily values for sensor data or other information.

The graphical user interface 202B is shown as including a fifth region 220, which can present any log entries associated with Node A (e.g., stored as part of the status data 124, etc.). In this example, no log entries are present, indicating that there are no error messages or warnings to report for Node A. The graphical user interface 202B can include a sixth region 222, which in this example can include a plot of time series data of GPU memory utilization. The sixth region 222 is presented in part due to the current scroll position on the graphical user interface 202B. In some implementations, interactive elements such as scroll bars or other types of navigation elements can be presented to navigate or otherwise display different regions of the dashboard interfaces described herein.

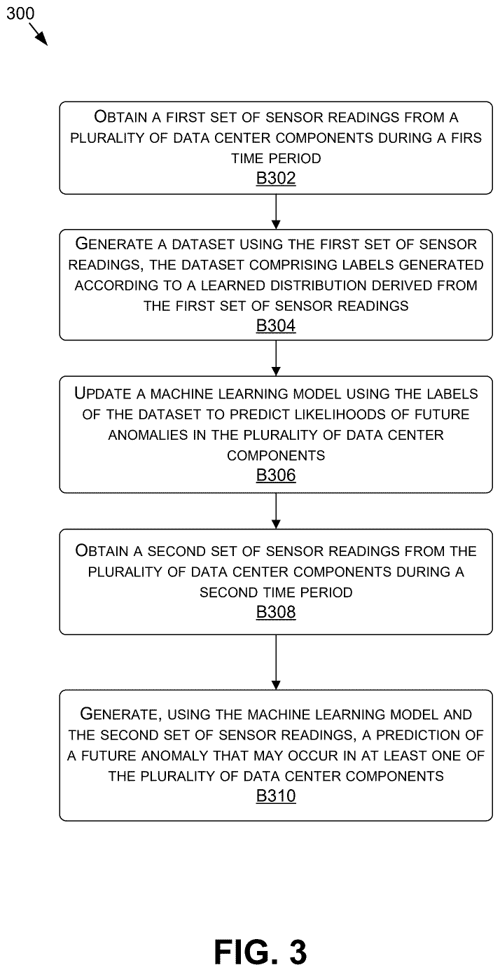

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for monitoring data center metrics using machine learning, in accordance with some embodiments of the present disclosure. The method 300, at block B302, can include obtaining a first set of sensor readings (e.g., sensor data 118 captured during normal operating conditions) from a plurality of data center components (e.g., data center components 104) of a data center during a first time period. The first set of sensor readings can be captured during normal operating conditions, such as during a maintenance window or when the data center is under a known workload or operating conditions. The first set of sensor readings can include information such as temperature, power consumption, processor and/or memory utilization, and/or other metrics that can be used to monitor the health and performance of the data center components. The sensor data can be collected from any of the data center components described herein, including but not limited to GPUs, PCIe Re-timers, HMCs, BMCs, OSes, FPGAs, Baseboards, NVMe devices, and PCIe Switches, among others.

The method 300, at block B304, can include generating a dataset (e.g., a training dataset 116) using the first set of sensor readings and a negative sampling function (e.g., as part of a MADI function, etc.). The dataset can include one or more labels 122 generated according to a learned distribution derived from the first set of sensor readings. The negative sampling function can be used to generate synthetic examples that occupy a feature space that is not occupied by the sensor data corresponding to normal operating conditions. The synthetic examples can be generated using a MADI function, which can model sensor readings of the data center components in a high-dimensional feature space. The learned distribution can be derived from the first set of sensor readings, which can be used to generate labels for one or more synthetic training examples (e.g., the synthetic data 120). The labels can indicate whether the corresponding sensor data or synthetic examples represent anomalous or non-anomalous conditions of the data center components, as described herein.

The method 300, at block B306, can include updating a machine learning model (e.g., the machine learning model 112) using the labels of the dataset to predict likelihoods of future anomalies in the plurality of data center components. The machine learning model can be trained using the dataset generated in block B304, which can include the first set of sensor readings and the synthetic examples generated using the negative sampling function. The machine learning model can be trained to predict the likelihood of future anomalies in the data center components based on the patterns and trends learned from the dataset. The machine learning model can be updated using various techniques, such as stochastic gradient descent or an Adam optimizer, to minimize the loss function and improve the accuracy of the predictions. The updated machine learning model can be used to predict the likelihood of future anomalies in the data center components, as described herein.

The method 300, at block B308, can include obtaining a second set of sensor readings (e.g., sensor data 118 captured from a period in which it is unknown whether anomalous readings occur) from the plurality of data center components during a second time period. The second set of sensor readings can be captured during a period in which it is unknown whether anomalous readings occur. The second set of sensor readings can include information such as temperature, power consumption, processor and/or memory utilization, and/or other metrics that can be used to monitor the health and performance of the data center components. The sensor data can be collected from any of the data center components described herein, including but not limited to GPUs, PCIe Re-timers, HMCs, BMCs, OSes, FPGAs, Baseboards, NVMe devices, and PCIe Switches, among others. The second set of sensor readings can be used as input to the machine learning model to generate predictions of potential future anomalies in the data center components.

The method 300, at block B310, can include generating, using the machine learning model and the second set of sensor readings, a prediction of a future anomaly (e.g., anomalies 130) that may occur in at least one of the plurality of data center components. The machine learning model can be executed using the second set of sensor readings as input to generate a prediction of a potential future anomaly in the data center components. The prediction can be based on the patterns and/or trends learned from the dataset used to update/train the machine learning model. The prediction can include a probability or likelihood that an anomaly may occur in the data center components, as well as information about the type of anomaly and the data center components that may be affected. The prediction can be used to provide an early warning system for potential issues in the data center, allowing for proactive maintenance and minimizing downtime.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models such as one or more large language models (LLMs), one or more small language models (SLMs), one or more vision language models (VLMs), and/or one or more multimodal language models (MMLMs), systems for performing light transport simulation, systems for performing collaborative content creation for 3D assets, systems implemented at least partially using cloud computing resources, and/or other types of systems.

### Example Computing Device

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). As such, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that allow the computing device 400 to communicate with other computing devices via an electronic communication network, included wired and/or wireless communications. The communication interface 410 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may allow the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that allow detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to allow the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### Example Data Center

FIG. 5 illustrates an example data center 500 that may be used in at least one embodiments of the present disclosure. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516(N) may correspond to a server having one or more of the above-mentioned computing resources. In addition, in some embodiments, the node C.R.s 516(1)-516(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may use distributed file system 538 for large-scale data processing (e.g., “big data”). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4—e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
obtain a first set of sensor readings from a plurality of data center components of a data center during a first time period;
generate a dataset using the first set of sensor readings and a negative sampling function, the dataset comprising labels generated according to a learned distribution derived from the first set of sensor readings;
update a machine learning model using the labels of the dataset to predict likelihoods of future anomalies in the plurality of data center components;
obtain a second set of sensor readings from the plurality of data center components during a second time period; and
generate, using the machine learning model and the second set of sensor readings, a prediction of a future anomaly that may occur in at least one of the plurality of data center components.

2. The one or more processors of claim 1, wherein the one or more circuits are to:
preprocess the first set of sensor readings by averaging common sensor readings corresponding to the same component of the plurality of data center components.

3. The one or more processors of claim 1, wherein the first set of sensor readings further comprises one or more of power consumption data, memory utilization data, or processing core utilization data.

4. The one or more processors of claim 1, wherein the plurality of data center components comprises one or more of a baseboard, a graphics processing unit (GPU), a field-programmable gate array (FPGA), a hardware service controller (HSC), a peripheral component interconnect (PCI) re-timer, or a PCI express (PCIe) switch.

5. The one or more processors of claim 1, wherein the one or more circuits are to:
obtain a set of status data from the plurality of data center components; and
generate a graphical interface based at least on the set of status data.

6. The one or more processors of claim 5, wherein the set of status data comprises one or more of a device status or a firmware version for the plurality of data center components.

7. The one or more processors of claim 5, wherein the one or more circuits are to:
generate the graphical interface to present the prediction of the future anomaly with the set of status data.

8. The one or more processors of claim 1, wherein the one or more circuits are to:
generate an alert upon the prediction satisfying an alert condition of the data center.

9. The one or more processors of claim 1, wherein the one or more circuits are to:
obtain a third set of sensor readings from the plurality of data center components of the data center during a third time period; and
responsive to determining that an update condition is satisfied:
generate a second dataset using the third set of sensor readings, and
update the machine learning model using the second dataset.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a small language model (SLM);
a system for performing generative AI operations using a vision language model (VLM);
a system for generating synthetic data;
a system incorporating one or more virtual machines (VMs);
a system implemented at least partially in a data center; or
a system implemented at least partially using cloud computing resources.

11. A system, comprising:
one or more processors to:
identify a machine learning model updated using a first set of sensor readings accessed from a plurality of data center components of a data center during a first time period, the machine learning model to predict likelihoods of future anomalies in the plurality of data center components;
obtain a second set of sensor readings from the plurality of data center components during a second time period;
determine, based at least on the first set of sensor readings, that the second set of sensor readings satisfies an update condition for the machine learning model; and
update the machine learning model based at least on the second set of sensor readings in response to determining that the second set of sensor readings satisfies the update condition.

12. The system of claim 11, wherein the one or more processors are to:
determine that the update condition is satisfied based at least on a Kullback-Leibler (KL) divergence between the first set of sensor readings and the second set of sensor readings.

13. The system of claim 11, wherein the one or more processors are to:
generate a second dataset using the second set of sensor readings, the second dataset comprising labels generated according to a learned distribution derived from the second set of sensor readings.

14. The system of claim 13, wherein the one or more processors are to:
generate the second dataset to include the second set of sensor readings and the first set of sensor readings.

15. The system of claim 13, wherein the one or more processors are to:
generate the second dataset to include one or more synthetic examples generated according to the learned distribution, the one or more synthetic examples representing at least one anomalous condition of at least one data center component of the plurality of data center components.

16. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a small language model (SLM);
a system for performing generative AI operations using a vision language model (VLM);
a system for generating synthetic data;
a system incorporating one or more virtual machines (VMs);
a system implemented at least partially in a data center; or a system implemented at least partially using cloud computing resources.

17. A method, comprising:
obtaining, using one or more processors, a dataset comprising labels generated according to a learned distribution derived from a first set of sensor readings associated with a plurality of data center components during a first time period;
updating, using the one or more processors, a machine learning model using the labels of the dataset to predict likelihoods of future anomalies in the plurality of data center components;
obtaining, using the one or more processors, a second set of sensor readings associated with the plurality of data center components during a second time period; and
applying, using the one or more processors, the second set of sensor readings to the machine learning model to generate a prediction of a future anomaly in the plurality of data center components.

18. The method of claim 17, further comprising:
preprocessing, using the one or more processors, the first set of sensor readings by averaging common sensor readings corresponding to the same component of the plurality of data center components.

19. The method of claim 17, wherein the first set of sensor readings further comprises one or more of power consumption data, memory utilization data, or processing core utilization data.

20. The method of claim 17, wherein the plurality of data center components comprises one or more of a baseboard, a graphics processing unit (GPU), a field-programmable gate array (FPGA), a hardware service controller (HSC), a peripheral component interconnect (PCI) re-timer, or a PCI express (PCIe) switch.
